(19) United States
(12) Patent Application Publication
(10) Pub. No.: US 2005/0215726 A1
(43) Pub. Date: Sep. 29, 2005

(54) Perfluoroelastomer molded article and method for producing the same

(75) Inventor: Takeshi Kuboyama, Shizuoka (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, Tokyo (JP)

(21) Appl. No.: 11/044,264

(22) Filed: Jan. 28, 2005

(30) Foreign Application Priority Data
Mar. 25, 2004 (JP) P.2004-088822

(51) Int. Cl. C08F 8/00; C08F 214/18

(52) U.S. Cl. 525/326.3; 525/374

(57) ABSTRACT

The present invention provides a perfluoroelastomer molded article comprising a perfluoroelastomer that contains a copolymerization unit derived from a monomer mixture comprising: a perfluoroolefin monomer; a perfluorovinyl ether monomer selected from the group consisting of a perfluoro(alkyl vinyl) ether, a perfluoro-(alkoxyl vinyl) ether and a mixture thereof; and a cure site monomer, wherein the molded article has a surface layer portion that has been crosslinked with a curing agent. Also disclosed are a method for producing the perfluoroelastomer molded article and a rubber material comprising the perfluoroelestomer molded article.

### FIELD OF THE INVENTION

The present invention relates to a perfluoroelastomer molded article reduced in sticking property to metal in a high-temperature or vacuum environment. The invention particularly relates to a perfluoroelastomer molded article suitable for semiconductor manufacturing equipment, liquid crystal manufacturing equipment and the like. Further, the invention relates to a method for producing such a perfluoroelastomer molded article.

### BACKGROUND OF THE INVENTION

Rubber seal materials such as rubber O-rings used in semiconductor manufacturing equipment, liquid crystal manufacturing equipment and the like are required to have cleanness such as low gas release and low metal elution for preventing the outside from being contaminated. In particular, rubber materials for semiconductor manufacturing equipment are required to have non-sticking property, heat resistance, plasma resistance and chemical resistance, as well as cleanness. Therefore, perfluoro rubbers excellent in heat resistance, plasma resistance and chemical resistance have been frequently used.

However, rubber materials often stick to metal surfaces to be sealed, which brings about the fatal problems of inhibiting the normal operation of equipment and the like at sites where opening and closing are frequently performed. At the time of maintenance, the seal materials adhere so strongly that they cannot be peeled off. When they are forcedly peeled off, rubber powders fall by rubbing, and even adversely affect the equipment later in some cases.

On the other hand, fluorine-based polymers have been considered to be rubber materials which are most difficult to stick to metal, because of their low surface energy. However, they show extremely high sticking strength, contrary to expectation. In particular, the perfluoro rubber seal materials have many opportunities to be exposed to vacuum or high temperatures, so that this problem becomes remarkable. Accordingly, an effective technique for reducing adhesion property or sticking property has been demanded.

As methods for reducing adhesion of rubber, there have been known (1) incorporation of oil into rubber, (2) treatment of forming a silicone reactive layer on the surface of a rubber material (see, for example, patent document 1), (3) blending with a silicone rubber (see, for example, patent document 2), (4) filling of a fluororesin powder or the like into a rubber (see, for example, patent document 3), (5) irradiation with a specific kind of plasma, (6) elimination of low molecules, and the like.

However, the method (1) suffers from the problems of contamination caused by oil exudation and decreased strength of the material itself. According to the method (2), the perfluoro rubber material is used in a high-temperature environment of 200° C. or more in many cases, so that an amido bond, a urethane bond and a biuret bond binding the silicone resins to each other or the silicone resin to the rubber base material are dissociated by heat, and further, the silicone resin itself is thermally deteriorated, thereby failing to exhibit non-adhesion property. The method (3) also causes thermal deterioration of the silicone rubber and insufficient non-adhesion property, and has a disadvantage in that the strength of the perfluoro rubber material decreases. According to a simple filling method such as the method (4), the resin powder appears on a surface layer portion in small amounts, so that sufficient non-adhesion property is not exhibited. When the filling amount of the resin powder is increased in order to solve this problem, there arise the problems of decreased elasticity and strength of the rubber material and deterioration in crosslink moldability. According to the method (5), the plasma etched rubber surface becomes uneven to remarkably deteriorate sealing property. In the method (6), there has been proposed a method of extracting low molecular weight components contained in a rubber elastomer with a solvent such as toluene, but sufficient non-sticking property cannot be obtained.

As described above, according to the conventional art, it has been difficult to impart non-sticking property and non-adhesion property to perfluoro rubber materials for use in a clean environment and in a severe environment such as a high-temperature or vacuum environment.
Patent Document 1: JP 1-301725 A
Patent Document 2: JP 5-339456 A
Patent Document 3: Japanese Patent No. 3009676

### SUMMARY OF THE INVENTION

An object of the invention is to solve the above-mentioned problems and to provide a perfluoroelastomer molded article exhibiting good non-adhesion property or non-sticking property even in a severe environment such as a high-temperature or vacuum environment, and particularly, suitable as a rubber material for semiconductor manufacturing equipment, semiconductor conveyance equipment, food processing equipment, medical parts and the like.

Another object of the invention is to provide a method for producing the perfluoroelastomer molded article.

A still other object of the invention is to provide a rubber material comprising the perfluoroelastomer molded article.

A further still other object of the invention is to provide various applications of the rubber material. Other objects and effects of the invention will become apparent from the following description.

The present inventors have discovered that a perfluoroelastomer molded article becomes less apt to stick or adhere to metal even when brought into contact with metal in a high-temperature environment, by impregnating the perfluoroelastomer molded article with a specific solution capable of swelling the molded article and containing a curing agent, followed by heat treatment.

That is, the forgoing objects of the invention have been achieved by providing the following perfluoroelastomer molded articles, methods for producing the same.

(1) A perfluoroelastomer molded article comprising a perfluoroelastomer that contains a copolymerization unit derived from a monomer mixture comprising:

a perfluoroolefin;

a perfluorovinyl ether selected from the group consisting of a perfluoro(alkyl vinyl) ether, a perfluoro(alkoxyl vinyl) ether and a mixture thereof; and

a cure site monomer,

wherein the molded article has a surface layer portion that has been crosslinked with a curing agent, and the molded article has a degree of crosslinking that gradually decreases from the surface toward the inside thereof.

(2) The perfluoroelastomer molded article described in the above (1), wherein the curing agent is a compound represented by the following general formula: 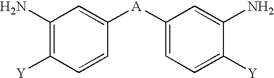
wherein Y's, which may be the same or different, represent —OH, —NH₂ or —SH, and A represents an alkylene group having 1 to 6 carbon atoms, a perfluoroalkylene group having 1 to 10 carbon atoms, a single bond, O or CO;

(3) The perfluoroelastomer molded article described in the above (1) or (2), having a sticking force to a metal at a temperature of 200° C. to 350° C. that is 70% or less of a sticking force thereof to the metal before the crosslinking of the surface layer portion;

(4) The perfluoroelastomer molded article described in any one of the above (1) to (3), having a helium leak amount is 1×10⁻⁸ (Pa·m³/sec) or less;

(5) A method for producing a perfluoroelastomer molded article, which comprises:
impregnating a molded article comprising a perfluoroelastomer that contains a copolymerization unit derived from a monomer mixture comprising:
   a perfluoroolefin monomer;
   a perfluorovinyl ether monomer selected from the group consisting of a perfluoro(alkyl vinyl) ether, a perfluoro(alkoxyl vinyl) ether and a mixture thereof; and
   a cure site monomer,
      with a solution which is capable of swelling the molded article and which contains a curing agent; and then,
heat treating the impregnated molded article to crosslink a surface layer portion thereof;

(6) The method described in the above (5), wherein the solution comprises a solvent mixture comprising:
a nonflammable fluorosolvent; and
a carboxylic acid, an alcohol, a ketone or an ester;

(7) The method described in the above (6), wherein the nonflammable fluorosolvent is a hydrofluoroether or a hydrofluorocarbon;

(8) The method described in any one of the above (5) to (7), wherein the curing agent is a compound represented by the following general formula: 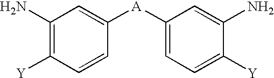
wherein Y's, which may be the same or different, represent —OH, —NH₂ or —SH, and A represents an alkylene group having 1 to 6 carbon atoms, a perfluoroalkylene group having 1 to 10 carbon atoms, a single bond, O or CO;

(9) The method described in any one of the above (5) to (8), wherein the impregnation is carried out under pressure and heating; and

(10) The method described in any one of the above (5) to (9), further comprising, prior to the impregnation and heat treatment steps, crosslinking the perfluoroelastomer molded article so as to give a crosslinking time of Tc(30) to Tc(100).

Further, the invention also provides a rubber material comprising the perfluoroelastomer molded article. Based on excellent non-adhesion property and non-sticking property of the perfluoroelastomer molded article, the rubber material is suitably used for semiconductor manufacturing equipment, semiconductor conveyance equipment, liquid crystal manufacturing equipment, food manufacturing equipment, food conveyance equipment, food storage equipment and medical parts.

It is an important requirement that the surface layer portion of the perfluoroelastomer molded article is crosslinked with a curing agent. This restricts the mobility of molecular chains of the perfluoroelastomer molded article surface, and restrains follow thereof to fine unevenness of a metal surface. Further, the van der Waals force on the metal surface and the action with active hydroxyl groups of the metal surface, such as hydrogen bonding, are also restrained to maintain excellent surface stability for a long period of time, resulting in the expression of good non-adhesion property and non-sticking property.

According to the invention, there is obtained a perfluoroelastomer molded article exhibiting good non-adhesion property or non-sticking property even in a severe environment such as a high-temperature or vacuum environment, and particularly suitable as a rubber material for semiconductor manufacturing equipment, semiconductor conveyance equipment, liquid crystal equipment, food manufacturing equipment, food conveyance equipment, food storage equipment, medical parts and the like.

### BRIEF DESCRIPTION OF THE DRAWING

FIG. 1 schematically illustrates the helium leak test made in the Examples.

### DETAILED DESCRIPTION OF THE INVENTION

The invention will be described in detail below.

In a preferred embodiment, the perfluoroelastomer molded article of the invention is made to have a sticking force to a metal at a temperature of 200° C. to 350° C. that is 70% or less as compared to a sticking force thereof to the metal before the crosslinking treatment. Further, a decrease in sealing property associated with the crosslinking treatment is suppressed to the extent that the perfluoroelastomer molded article has a helium leak amount of 1×10⁻⁸ (Pa·m³/sec) or less, which causes no problem even in vacuum applications.

In the invention, the perfluoroelastomer is obtained from a monomer mixture containing: a perfluoroolefin monomer; a perfluorovinyl ether monomer selected from the group consisting of a perfluoro(alkyl vinyl) ether, a perfluoro(alkoxy vinyl) ether and a mixture thereof; and a cure site monomer, preferably, selected from the group consisting of a nitrile-containing fluorinated olefin and a nitrile-containing fluorinated vinyl ether. The perfluoroelastomer may be a polymer further comprising a fourth ingredient such as vinylidene fluoride, hexafluoro-propylene or ethylene, in addition to the foregoing three monomers, or may be a polymer having a peroxide crosslink site such as iodine or bromine.

Further, the above-mentioned perfluoroelastomer, which is to be subjected to the treatment described later, may be a crosslinked molded article. As a method for crosslinking and molding the perfluoroelastomer, any method may be used. For example, it can be carried out by chemical crosslinking and molding using a chemical crosslinking agent. Alternatively, crosslinking can be performed by ionizing radiation after preforming. The chemical crosslinking and the ionizing radiation may be performed in combination. The molding method using a chemical crosslinking agent is more preferred. The chemical crosslinking does not require preforming which is required for the ionizing radiation crosslinking, and provides good moldability and also good mechanical strength of the molded article. In particular, the molded article obtained by using a chemical crosslinking agent, including an organotin compound-based curing agent, a crosslinking agent such as a bisaminophenol, a tetraaminophenol or a bisaminothiophenol, and a conventional peroxide crosslinking agent using fluorinated TAIC as a cocrosslinking agent, shows excellent heat resistance and chemical resistance.

The organotin compounds include, for example, allyltin, propargyltin, triphenyltin and allenyltin compounds, but are not limited thereto. Further, these curing agents may be used together. Of these, tetraalkyltin compounds and tetraaryltin compounds are preferred. These compounds are useful curing agents for a perfluoroelastomer having a nitrile-containing cure site. Further, the simultaneous use of a curing accelerator can improve the curing rate. The curing accelerators include, for example, ammonium salts such as ammonium perfluorooctanoate, ammonium perfluoroacetate, ammonium thiocyanate and ammonium sulfamate, but are not limited thereto.

The bisaminophenols, the tetraaminophenols and the bisaminothiophenols include, for example, 4,4′-[2,2,2-tri-fluoro-1-(trifluoromethyl)ethylidene]bis(2-aminophenol), 4,4′-sulfonylbis(2-aminophenol), 3,3′-diaminobenzidene, 3,3′,4,4′-tetraaminobenzophenone and 2,2′-bis(3-mercapto-4-hydroxyphenyl)hexafluoropropane, but are not limited thereto. Further, these crosslinking agents may be used in combination of two or more thereof.

The peroxide crosslinking agents include di-t-butyl peroxide, dicumyl peroxide, t-butylcumyl peroxide, 1,1-di(t-butylperoxy)-3,3,5-trimethylcyclohexane, benzoyl peroxide, n-butyl-4,4-bis(t-butylperoxy) valerate, α,α′-bis(t-butylperoxy)diisopropylbenzene, 2,5-dimethyl-2,5-bis(t-butylperoxy)hexane and 2,5-dimethyl-2,5-bis(t-butylperoxy)hexyne-3, but are not limited thereto. Further, these crosslinking agents may be used in combination of two or more thereof.

A perfluoroelastomer molded article excellent in heat resistance and chemical resistance can be obtained by blending the above-mentioned curing agent and crosslinking agent in an amount of 0.1 to 20 parts by weight, preferably in an amount of 1 to 10 parts by weight, based on 100 parts by weight of the perfluoroelastomer.

Further, the above-mentioned perfluoroelastomer may be blended with an additive which is widely used in compounding of a perfluoroelastomer, including an inorganic filler such as carbon black, silica, barium sulfate, titanium oxide, aluminum oxide, calcium carbonate, calcium silicate, magnesium silicate, aluminum silicate, zinc oxide, red iron oxide and a clay mineral (for example, wollastonite or mica); an organic filler such as a polytetrafluoroethylene resin, a polyethylene resin, a polypropylene resin, a phenol resin, a polyimide resin, a melamine resin and a silicone resin; and fiber for reinforcement such as cotton, rayon fiber, nylon fiber and polyester fiber, as long as the additive has appropriate stability to the intended use conditions. The inclusion of these compounds can enhance the strength, hardness, plasma resistance, radical resistance and non-sticking property of the perfluoroelastomer molded article of the invention.

When the chemical crosslinking is employed, secondary crosslinking by means of an oven or the like is generally performed, in addition to primary crosslinking by pres molding or the like. The secondary crosslinking is usually performed at a temperature of 150 to 350° C. for about 1 to 50 hours.

Concerning the ionizing radiation, on the other hand, any kind of ionizing radiation is applicable in the invention, as long as it is an electromagnetic wave or particle beam having the ability to ionize air directly or indirectly. Examples thereof include but are not limited to an α-ray, a β-ray, a γ-ray, a deuteron beam, a proton beam, a neutron ray, an X-ray and an electron beam. These ionizing radiations may be used in combination. In the invention, a γ-ray is particularly preferably used. A γ-ray can achieve uniform crosslinking because of its high penetrating power. Further, when a γ-ray irradiation is to be performed, the irradiation is preferably carried out under vacuum or in an inert gas atmosphere. It is unfavorable that the irradiation is performed in an oxygen atmosphere, because the decomposition reaction of the polymer becomes a rate-determining factor. When the ionizing radiation is irradiated to the copolymer, the crosslinking and decomposition of the polymer occur at the same time. When the amount of irradiation is too large, the physical properties deteriorate because of the decomposition of the polymer. On the other hand, when the amount of irradiation is too small, the heat resistance deteriorates because of a lack of crosslinking of the polymer. In the invention, therefore, the irradiation amount of ionizing radiation is preferably within an appropriate range. The total irradiation amount of ionizing radiation is preferably from 10 to 500 kGy, more preferably from 30 to 350 kGy, and still more preferably from 60 to 300 kGy. The adjustment of the amount of ionizing radiation within the above-mentioned range provides a perfluoroelastomer molded article having good physical properties.

The perfluoroelastomer molded article obtained above, a molded article after the primary crosslinking or a molded article in the course of the primary crosslinking is impregnated with a solution capable of swelling the molded article and containing at least one curing agent, and then, heat treated, whereby a perfluoroelastomer molded article having remarkably excellent non-sticking property to metal can be obtained. The term “molded article after the primary crosslinking” as used herein means a molded article having a crosslinking time of Tc(90) to Tc(100). In this specification, crosslinking times at which torques corresponding to 100%, 90% and 30% of the maximum torque are exhibited in a test of the degree of crosslinking (in which the viscosity of the molded article is measured with time using a rheometer while the molded article is subjected to crosslinking) are represented by Tc(100), Tc(90) and Tc(30), respectively. Further, the term “molded article in the course of the primary crosslinking” as used herein means a molded article having a crosslinking time of Tc(30) to Tc(90). There is no limitation on the degree of crosslinking of the molded article to be subjected to the impregnation treatment. However, the molded article after the primary crosslinking or the molded article in the course of the primary crosslinking is advantageous, because the curing agent easily penetrates from the surface of the molded article to the inside thereof, when the molded article is impregnated with the solution.

As the curing agent which is a solute of the solution, there is available an organotin compound-based curing agent, a conventional peroxide crosslinking agent using fluorinated TAIC as a cocrosslinking agent, or the like. However, the compound represented by the following general formula is particularly preferred: 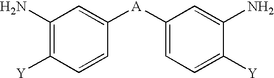
wherein Y's, which may be the same or different, represent —OH, —NH₂ or —SH, and A represents an alkylene group having 1 to 6 carbon atoms, a perfluoroalkylene group having 1 to 10 carbon atoms, a single bond, O or CO.

The curing agent represented by the general formula not only readily reacts with the cure site monomer, which is preferably selected from the group consisting of a nitrile-containing fluorinated olefin and a nitrile-containing fluorinated vinyl ether, thereby deriving an oxazole ring, an imidazole ring or a thiazole ring, but also it can form an amide linkage with a carboxyl group in the polymer. Accordingly, this is advantageous for an improvement in crosslinking density on the surface.

It is desirable that the solvent of the solution is a mixture of a nonflammable fluorosolvent and a carboxylic acid, an alcohol, a ketone or an ester. The nonflammable fluorosolvent is preferably a hydrofluoroether, a hydrofluorocarbon, a perfluorocarbon, a perfluoropolyether or a hydrochlorofluorocarbon. More preferred are a hydrofluoroether and a hydrofluorocarbon, and these are readily compatible with a carboxylic acid, an alcohol, a ketone and an ester. Further, as the carboxylic acid, the alcohol, the ketone and the ester, it is necessary to select those which can dissolve the above-mentioned crosslinking agent. More preferred is an alcohol having high solubility, and still more preferred is methanol.

The proportion of the nonflammable fluorosolvent in the solvent is from 20 to 95% by weight, and preferably from 40 to 90% by weight. The remainder of the solvent is a carboxylic acid, an alcohol, a ketone or an ester.

Further, the concentration of the curing agent in the treating solution is from 0.1 to 20% by weight, and preferably from 0.5 to 10% by weight.

There is no limitation on an impregnating method of the above-mentioned solution. Examples thereof include a method using a supersonic generator such as an ultrasonic generator or a megasonic generator, and a method of treating in a pressure vessel under heating and pressure. The impregnation temperature is desirably from 0 to 170° C., and more preferably from 10 to 150° C. When the impregnation temperature is too low, the curing agent precipitates, or the time until the molded article reaches equilibrium swelling is prolonged, which causes a significant reduction in workability. When the treatment is conducted at an impregnation temperature of 60° C. or more, the solvent evaporates. Accordingly, the treatment in a pressure vessel is desired. Under heating and pressure, the curing agent readily dissolves in the solution, and penetrates into and swells the perfluoroelastomer molded article decreasingly from the surface.

Although the impregnation amount is adjusted by the concentration of the curing agent, it is desirable that the impregnation time is adjusted to 5 seconds to 50 hours. When the concentration of the curing agent in the treating solution is too high, or when the impregnation time is too long, the crosslinking density of the molded article surface becomes excessively high to increase hardness, resulting in a decrease in sealing property. It is therefore necessary to select suitable conditions as the concentration of the curing agent in the treating solution, the impregnation temperature, the impregnation time and the like.

After the necessary swelling amount is attained by impregnation, the perfluoroelastomer molded article is cooled.

In the course of cooling, the solubility of the curing agent in the perfluoroelastomer molded article decreases, and there is obtained a perfluoroelastomer molded article having a skewed concentration distribution in which the concentration of the curing agent gradually decreases from the surface to the inside depending on the swelling amount without migration of the curing agent to the surface.

Then, the perfluoroelastomer molded article is heat treated to crosslink the portions impregnated with the curing agent. The crosslinking time and the crosslinking temperature are desired to be 30 minutes to 100 hours and 100 to 300° C., respectively. The crosslinking time and temperature are more preferably 30 minutes to 72 hours and 120 to 240° C., respectively, and optimally selected depending on the kind of curing agent with which the molded article has been impregnated.

The perfluoroelastomer molded article of the invention in which the surface layer portion is highly crosslinked compared to the inside can be obtained by the foregoing method. Although there is no particular limitation on the hardness of the perfluoroelastomer molded article, it is desirable that the molded article has a JIS-A hardness ranging from 40 to 95. Too low a hardness results in insufficient non-adhesion property and non-sticking property, whereas too high a hardness unfavorably causes deterioration of sealing property and a decrease in elongation.

The perfluoroelastomer molded article of the invention is excellent in plasma resistance and particularly in non-sticking property, as well as in heat resistance and chemical resistance. Accordingly, the perfluoroelastomer molded article is suitable as a rubber material for equipment and parts used in severe environments such as high-temperature or vacuum environments, such as semiconductor manufacturing equipment, semiconductor conveyance equipment, food manufacturing equipment, food conveyance equipment, food storage equipment and medical parts. For example, in the semiconductor manufacturing field, the molded article can be used in semiconductor manufacturing equipment such as a wet washing apparatus, a plasma etching apparatus, a plasma ashing apparatus, a plasma CVD apparatus, an ion injection apparatus and a sputtering apparatus, and wafer conveyance instruments which are auxiliary equipment of these apparatus. The invention also includes a rubber material comprising the above-described perfluoroelastomer suitable for a semiconductor manufacturing equipment, a semiconductor conveyance equipment, a food manufacturing equipment, a food conveyance equipment, a food storage equipment and medical parts.

### EXAMPLES

The present invention will be illustrated in greater detail with reference to the following Example and Comparative Example, but the invention should not be construed as being limited thereto.

### Example 1

In a stainless steel autoclave having a volume of 500 ml, 200 ml of distilled water, 2.5 g of ammonium perfluorooctanoate and 4.4 g of Na₂HPO₄.12H₂O were charged, and then, the inside thereof was replaced by nitrogen gas, followed by pressure reduction. After cooling this autoclave to 50° C., 32 g of tetrafluoroethylene, 68 g of perfluoromethyl vinyl ether and 6.4 g of perfluoro-8-cyano-5-methyl-3,6-dioxa-1-octene were charged therein, and the temperature thereof was elevated to 80° C. Then, 0.75 g of sodium sulfite and 3.75 g of ammonium persulfate were each charged in the form of a 25-ml aqueous solution, and polymerization was initiated. After continuation of the polymerization for 20 hours, an unreacted gas was purged, and an aqueous latex formed therein was taken out. Then, the aqueous latex was subjected to a salting-out procedure using a 10% aqueous solution of sodium chloride, followed by drying to obtain 44 g of a crumb rubber-like ternary copolymer. From the results of infrared absorption analysis, this ternary copolymer had a copolymerization composition of 62 mol % of tetrafluoroethylene, 37 mol % of perfluoromethyl vinyl ether and 1.0 mol % of a component having a nitrile group characteristic absorption of 2268 cm⁻¹.

Per 100 parts by weight of the resulting ternary copolymer, one part of 2,2′-bis(3-amino-4-hydroxyphenyl)hexafluoropropane (“BIS-AP-AF” manufactured by Central Glass Co., Ltd.), 2 parts by weight of dicyclohexyl-18-crown-6 (“18-Crown-6 (ether)” manufactured by Wako Pure Chemical Industries, Ltd.), 2 parts by weight of zinc white (“No. 1” manufactured by Sakai Chemical Industry Co., Ltd.) and 20 parts by weight of MT carbon (manufactured by Cancard) were blended, and kneaded by means of an open roll. Then, primary crosslinking (190° C., 20 minutes) was performed to obtain a primary crosslinked molded article.

Then, the resulting primary crosslinked molded article was impregnated with a solution containing 100 g of HFC (hydrofluorocarbon), 30 g of methanol and 7 g of 2,2′-bis(3-amino-4-hydroxyphenyl)hexafluoropropane for 30 minutes, and then, taken out from the solution. After air drying, secondary crosslinking (240° C., 48 minutes) was performed to obtain sample A.

### Comparative Example 1

For comparison, the above-mentioned primary crosslinked molded article was subjected to secondary crosslinking (240° C., 48 minutes) without impregnation, thereby obtaining sample B.

Sticking Test

A test piece having a thickness of 6 mm and a diameter of 10 mm was cut out from each molded article described above, and compressed, while being interposed between SUS 316L plates having a thickness of 2 mm and a diameter of 90 mm, or between aluminum plates from the both sides until the thickness of the test piece was reduced to 25%. The compression plates including the test piece were placed in a gear oven at 200° C. and allowed to stand for 22 hours. Then, the compression plates were cooled, and vertically pulled at a rate of 10 mm/sec with an autograph to measure the maximum load at that time. The results obtained are shown in Table 1.

Helium Leak Test

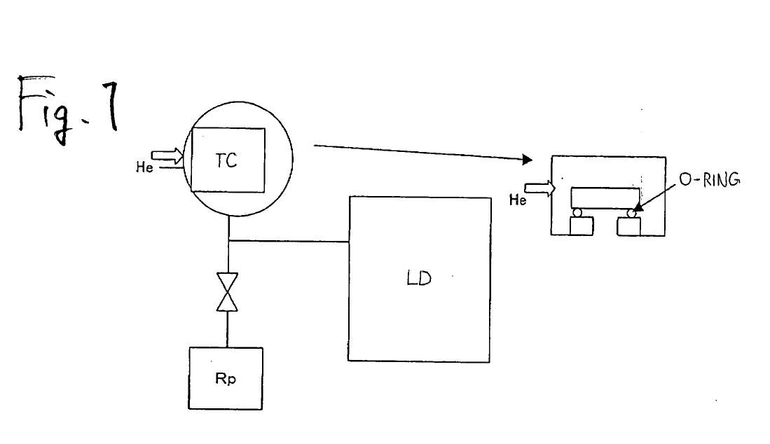

An O-ring-shaped test piece of the sample was disposed in a test chamber TC as shown in FIG. 1. Into the test chamber TC, helium gas was supplied and, one minute after the start of the helium gas supply, the leak amount from the test chamber in terms of contact surface leakage was measured using a leak detector main body LD. In FIG. 1, the reference numeral Rp represents a rotary pump. This test was made using “Helium Leak Detector UL200” manufactured by LEYBOLD. The test conditions were as follows: Temperature: room temperature, He gas pressure: 1 kgf/cm², Shape of sample: AS568B-214 (Aeronautical Standard for O-ring), and Compression rate of test piece: 25%. The results obtained are shown in Table 1.

TABLE 1
Test Results

| | |
|---|---|
| Sticking Force [N] | He Leak |

| | SUS 316L | Aluminum | Amount |
|---|---|---|---|
| | Plate | Plate | (Pa · m³/sec) |
| Sample A | 150 | 90 | 3.0 × 10⁻¹¹ |
| Sample B | 270 | 170 | 8.5 × 10⁻¹¹ |

As shown in Table 1, sample A whose surface has been crosslinked according to the invention is decreased in sticking force to about half, compared to sample B. This proves that non-adhesion property and non-sticking property are improved. Further, the helium leak amount of sample A is at the same level as that of sample B.

While the invention has been described in detail and with reference to specific embodiments thereof, it will be apparent to one skilled in the art that various changes and modifications can be made therein without departing from the spirit and scope thereof.

This application is based on Japanese Patent Application No. 2004-088822 filed on Mar. 25, 2004, the contents thereof being herein incorporated by reference.

1. A perfluoroelastomer molded article comprising a perfluoroelastomer that contains a copolymerization unit derived from a monomer mixture comprising:
a perfluoroolefin monomer;
a perfluorovinyl ether monomer selected from the group consisting of a perfluoro(alkyl vinyl) ether, a perfluoro(alkoxyl vinyl) ether and a mixture thereof; and
a cure site monomer,
wherein the molded article has a surface layer portion that has been crosslinked with a curing agent, and the molded article has a degree of crosslinking that gradually decreases from the surface toward the inside thereof.

2. The perfluoroelastomer molded article according to claim 1, wherein the curing agent is a compound represented by the following general formula: 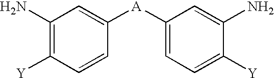
wherein Y's, which may be the same or different, represent —OH, —NH₂ or —SH, and A represents an alkylene group having 1 to 6 carbon atoms, a perfluoroalkylene group having 1 to 10 carbon atoms, a single bond, O or CO.

3. The perfluoroelastomer molded article according to claim 1, having a sticking force to a metal at a temperature of 200° C. to 350° C. that is 70% or less of a sticking force thereof to the metal before the crosslinking of the surface layer portion.

4. The perfluoroelastomer molded article according to claim 1, having a helium leak amount of 1×10⁻⁸ (Pa·m³/sec) or less.

5. A method for producing a perfluoroelastomer molded article, which comprises:
impregnating a molded article comprising a perfluoroelastomer that contains a copolymerization unit derived from a monomer mixture comprising:
a perfluoroolefin monomer;
a perfluorovinyl ether monomer selected from the group consisting of a perfluoro(alkyl vinyl) ether, a perfluoro(alkoxyl vinyl) ether and a mixture thereof; and
a cure site monomer,
with a solution which is capable of swelling the molded article and which contains a curing agent; and then,
heat treating the impregnated molded article to crosslink a surface layer portion thereof.

6. The method according to claim 5, wherein the solution comprises a solvent mixture comprising:
a nonflammable fluorosolvent; and
a carboxylic acid, an alcohol, a ketone or an ester.

7. The method according to claim 6, wherein the nonflammable fluorosolvent is a hydrofluoroether or a hydrofluorocarbon.

8. The method according to claim 5, wherein the curing agent is a compound represented by the following general formula: 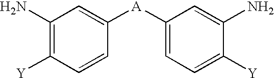
wherein Y's, which may be the same or different, represent —OH, —NH₂ or —SH, and A represents an alkylene group having 1 to 6 carbon atoms, a perfluoroalkylene group having 1 to 10 carbon atoms, a single bond, O or CO.

9. The method according to claim 5, wherein the impregnation is carried out under pressure and heating.

10. The method according to claim 5, further comprising, prior to the impregnation and heat treatment steps, crosslinking the perfluoroelastomer molded article so as to give a crosslinking time of Tc(30) to Tc(100).

11. A rubber material comprising the perfluoroelastomer molded article according to claim 1.
